(19) United States
(12) Patent Application Publication
(10) Pub. No.: US 2007/0061262 A1
(43) Pub. Date: Mar. 15, 2007

(54) System and method for populating information handling system music devices with music

(76) Inventors: Charles Morton, Leander, TX (US); Joshua N. Alperin, Austin, TX (US)

Correspondence Address: HAMILTON & TERRILE, LLP, P.O. BOX 203518, AUSTIN, TX, 78720, US

(21) Appl. No.: 11/225,340

(22) Filed: Sep. 13, 2005

(51) Int. Cl. G06Q 99/00

(52) U.S. Cl. 705/51

(57) ABSTRACT

Portable music devices are manufactured prepopulated with songs selected by the users who placed orders for the devices so that the devices are delivered to the users ready to play the songs selected by the users. An order engine interfaced with the Internet provides users with song titles based on a variety of factors, such as music genre type, music popularity and demographic information associated with an end user of the device. A copy engine copies songs selected by the user to the portable music device before shipment of the device to the end user. In one embodiment, songs are copied based on proof of rights by a user to the use of the songs, such as through proof of ownership of a CD having the songs or through interaction with a digital rights management server.

### BACKGROUND OF THE INVENTION

1. Field of the Invention

The present invention relates in general to the field of information handling system music devices, and more particularly to a system and method for populating information handling system music devices with music.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have morphed from work tools found primarily in an office environment into entertainment devices that store and play multimedia information such as music songs and video movies. The transformation of information handling systems into entertainment devices is illustrated by the development of portable music players, often referred to as MP3 players after the MP3 audio compression standard used to store the music. The transformation began with the introduction of music stored in digital form, such as on Compact Discs, instead of analog form, such as in albums or cassette tapes. Digital information, including digital audio information, is readily suited for storage on information handling systems, however, uncompressed digital samples of audible sounds tend to consume considerable amounts of storage space. Initially, storage constraints restricted the usefulness of information handling systems as multimedia devices since only large storage devices could save substantial numbers of songs. Over time, the capacity of storage devices has increased considerably and the introduction of compressed audio formats, like MP3 or WMV, has enabled portable devices to store an increasing number of songs. As an example, portable music devices sized to fit in the pockets of a user are now built with miniature hard disk drives having a capacity of 40 GB, enough memory to store over ten thousand songs formatted with MP3.

In an effort to keep the size of portable music devices to a minimum while maximizing operational time on an internal battery charge, the hardware, firmware and software within a typical device is generally pretty basic. For instance, a typical portable music device has a CPU of relatively low computing power that runs an interface application to present a user interface on a relatively small LCD screen. The user interface guides the user through basic functions, such as viewing and selecting stored songs, but is limited in its ability to present information and thus not always intuitive to use. Generally the user stores and otherwise manages songs on the portable music device by interfacing the device with an information handling system through a standardized interface, such as a USB interface. The information handling system interacts with the portable music device by treating the device as an external storage device. Users typically manage information on the portable storage device with an application running on the information handling system that coordinates the transfer of songs to the device and manages the organization of the songs, such as in albums or by artist. Often users that are new to the portable music device hesitate to fully use the device due to the learning curve of associated with interacting with the device interface and information handling system application. For instance, in order to store music on the device, the user typically has to download music from a network site or format music on a computer to a file that is compatible with the device. For a new user, delays associated with learning to use an application or downloading music has a negative impact on the experience of using the device.

### SUMMARY OF THE INVENTION

Therefore a need has arisen for a system and method which prepopulates a portable music device with songs for shipment to user.

In accordance with the present invention, a system and method are provided which substantially reduce the disadvantages and problems associated with previous methods and systems for populating a portable music device with songs. Portable music devices are prepopulated with songs selected by a user before shipment of the portable music device to the user so that the portable music device is delivered ready to play the songs selected by the user.

More specifically, a device order engine interfaces with a network, such as the Internet, to accept orders for portable music devices. A song order engine presents a graphical user interface to a user through the network to allow the user to order the portable music device prepopulated with songs selected by the user. For instance, the song order engine presents songs individually, by genre, by artist, by popularity or other factors. For instance, song list generation engine creates song lists based on factors input by the user, such as demographic factors, so that the user may select from the list or may select the entire list. A copy engine copies the songs selected by the user to a storage device of the portable music device so that the portable music device is delivered to the user ready to play the selected songs. The song order engine allows the user flexibility in configuring songs in desired groups, with desired formats and desired encoding quality. In one embodiment, the song order engine allows the user to establish rights to copy the songs by, for instance, proof of ownership of a CD having the songs or interaction with a digital rights management server.

The present invention provides a number of important technical advantages. One example of an important technical advantage is that a portable music device ordered by a user will arrive prepopulated with songs selected by the user. Prepopulation of songs on a portable music device reduces the time that the user waits to use the device by reducing the need for the user to download songs or convert songs for transfer to the device. More rapid use of a device provides an improved user experience and greater motivation for a new user to learn how to use the device. In addition, a portable music device prepopulated with songs provides an ideal gift purchased by a consumer for a third party user. Prepopulation with songs having a variety of rights for use, such as rights to further copy or to use for a limited time period, provide a range of costs and convenience.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a system for manufacture of prepopulated portable music devices;

FIG. 2 depicts an example of a graphical user interface for ordering prepopulated portable music devices; and

FIG. 3 depicts a flow diagram of a process for manufacture of prepopulated portable music devices.

### DETAILED DESCRIPTION

Prepopulation of portable music devices at manufacture with songs selected by the purchaser of each portable music device improves the user experience by preparing the portable music device for use with desired music at receipt of the device from the manufacturer. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

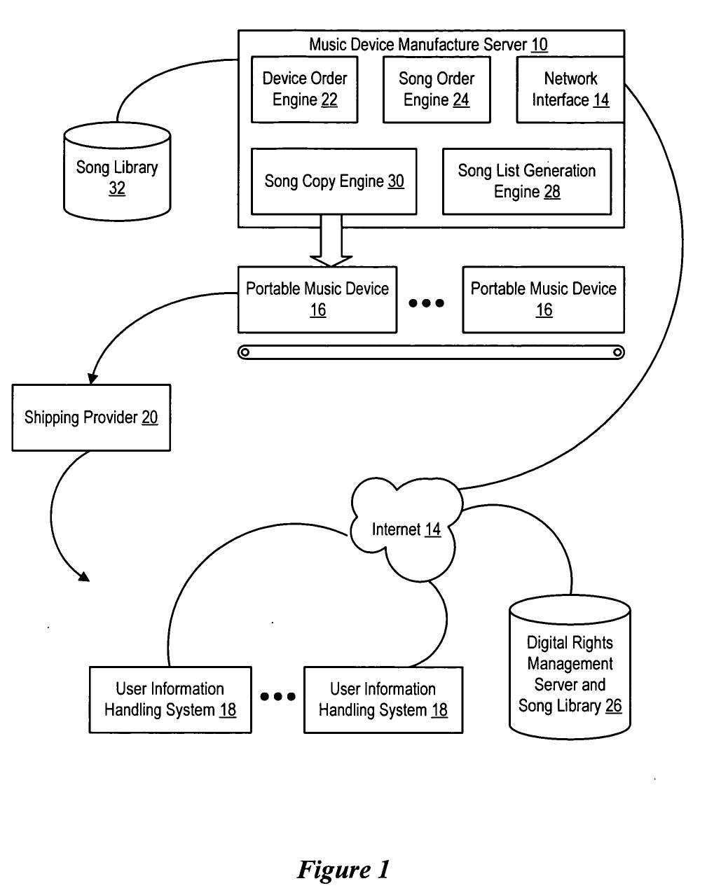

Referring now to FIG. 1, a system for manufacture of prepopulated portable music devices is depicted. A music device manufacture server 10 has a network interface 12 accessible to a public network, such as the Internet 14, through a network interface 14. Music device manufacture server 10 is, for instance, a server information handling system having a URL that individuals who desire to purchase a portable music device 16 may contact through Internet 14 and a user information handling system 18. User information handling system 18 presents a graphical user interface that allows the user to select one or more portable music devices 16 for delivery by a shipping provider 20 with the device prepopulated by one or more songs selected by the user. Portable music devices 16 generally are portable information handling systems but specialized for storing and playing music. For instance, a portable music device typically includes a miniaturized hard disk drive or EEPROM that provides permanent storage of songs, a codec for creating audio signals from stored digital songs, a CPU and a display for presenting song-related functions to a user. Portable music devices differ from portable information handling systems in that portable music devices typically do not run applications that perform functions beyond playing or supporting the playing of music while portable information handling systems allow users to load and run additional applications for functions beyond the playing of music.

To order a portable music device with prepopulated songs, a user information handling system 18 interfaces through Internet 14 with a device order engine 22 to select the type of portable music device 16 for delivery. For instances, portable music devices typically varying in the size of the permanent storage available for storing music. Once an order for a portable music device 16 is taken, a song order engine 24 allows the user to make selections from song titles for songs to be prepopulated to the portable music device. The song order engine provides songs for purchase with a variety of options, rights, and recording quality. For instance, the user may select songs individually by title, artist, genre or album, or may request creation of random lists from a song list generation engine 28 based on a variety of factors, such as song popularity or demographic characteristics of the end user like age or profession. As another example, the cost of songs requested by the user may vary based on rights the user has or requests for the songs, such as an expiration date for use of the song, or the encode quality used to copy the songs, such as varying sample rates used to create an MP3 copy of a song. In one embodiment, a user selects songs for prepopulation to which the user already has rights, such as by showing ownership of a CD with the songs or retrieving songs from an external digital rights management server song library 26 interfaced through Internet 14.

Once the user selects song titles from a list of available titles, a song copy engine 30 interfaces with a song library 32 to retrieve the songs associated with the selected song titles and copy the songs to portable music device 16 with the prescribed rights, quality and other factors, such as a desired list order or file structure. For instance, the copying of selected songs to prepopulate a portable music device occurs as a step in the process of manufacture of the device. The songs are, for instance, copied to a storage device as an image before or after assembly of the storage device in a portable music device 16. A physical network connection, such as an Ethernet or USB connection may be used or, if a portable music device 16 is so configured, a wireless network connection may be used. Once manufacture of an ordered portable music device 16 is complete, including prepopulation of the selected songs, shipping provider 20 ships the manufactured portable music device 16 to a designated end user site. As an example, portable music device 16 is shipped as a gift having songs selected randomly that are popular to individuals sharing demographic characteristics of the end user.

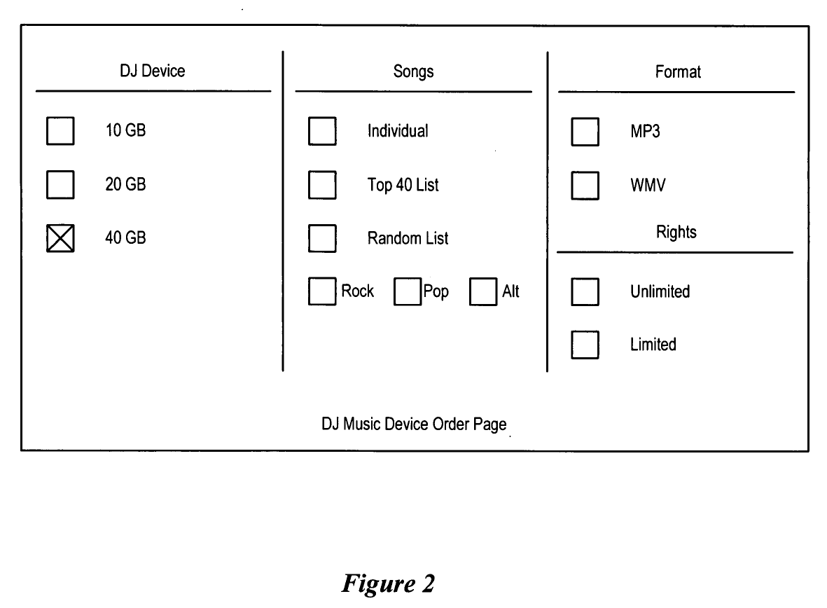

Referring now to FIG. 2, an example of a graphical user interface presented by device order engine 22 is depicted. The user is presented with plural device types for selection, such as devices having varying storage capacities of 10, 20 or 40 GB. The user is also presented with various options to selects songs to prepopulate the music device. For instance, the user my select songs from a variety of genre, like Rock, pop, or alternative, in a variety of ways, such as with a search of individual song titles, top 40 or other lists generated based on song popularity, or a randomly generated list. Thus, for instance, a user purchasing a portable music device as a gift for another end user may prepopulate the device with songs by selecting for purchase a whole list of randomly generated song titles of a desired genre. A format option allows the user to select the type of format used to store the selected songs on the device, such as MP3 or WMV formats of a selected sampling quality. The rights to the selected songs may be designated as unlimited or limited in one or more respects, such as expiration.

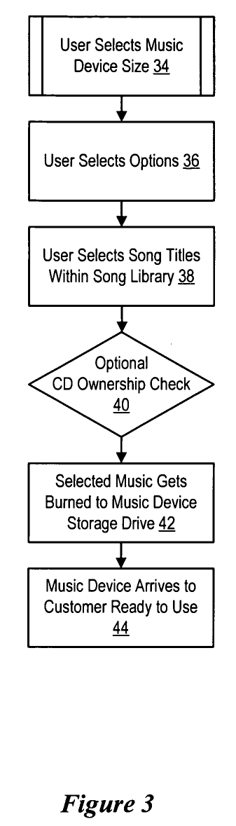

Referring now to FIG. 3, a flow diagram depicts a process for manufacture of prepopulated portable music devices. The process begins at step 34 with the selection by the user of a desired size for the portable music device. At step 36, the user selections options available with purchase of the device, such as selection of song titles to have associated songs copied to the device. At step 38, the user selects song titles of songs available for purchase from a song library. At step 40, the user is optionally provided with an opportunity to prove ownership rights to selected song titles, such as by proving ownership in a physical CD or rights in a digital rights management server. At step 42, the songs associated with song titles selected by the user are burned to the storage device of the selected portable music device. At step 44, the portable music device prepopulated with the selected songs is shipped to the end user configured for immediate use of the device to play the songs. In alternative embodiments, the process above may be applied to orders for other types of information handling systems with the songs selected by a user copied to an information handling system hard disk drive as part of an image.

Although the present invention has been described in detail, it should be understood that various changes, substitutions and alterations can be made hereto without departing from the spirit and scope of the invention as defined by the appended claims.

What is claimed is:

1. A method for manufacture of a portable music device, the method comprising:
receiving from a user through a network an order for a portable music device;
providing to the user through the network a plurality of songs available for selection;
receiving from the user through the network one or more selections from the plurality of songs;
copying songs associated with the selections to the portable music device; and
shipping the portable music device to the user with the songs copied on the portable music device.

2. The method of claim 1 further comprising:
receiving from the user through the network proof of rights in one or more songs by the user; and
copying the songs associated with the proof of rights to the portable music device.

3. The method of claim 1 further comprising:
receiving from the user through the network a format selection; and
copying the songs to the portable music device with the selected format.

4. The method of claim 3 wherein the selected format comprises MP3.

5. The method of claim 1 wherein providing a plurality of songs further comprises:
receiving from the user through the network demographic information; and
presenting songs available for selection based on the demographic information.

6. The method of claim 5 wherein presenting songs further comprises:
presenting one or more randomly generated lists of songs based on the demographic information;
receiving a request to copy all songs associated with one or more of the lists to the portable music device; and
copying the all requested songs to the portable music device.

7. The method of claim 1 wherein providing a plurality of songs further comprises:
receiving from the user a selected type of music;
determining a list of currently popular songs of the selected type of music; and
presenting the list of currently popular songs of the selected type of music to the user.

8. The method of claim 7 wherein:
receiving further comprises receiving a request to copy all songs associated with the list to the portable music device; and
copying further comprises copying all the requested songs from the list to the portable music device.

9. The method of claim 1 further comprising selecting a compression format and encode quality for copying the songs.

10. A system for manufacture of portable music devices, the system comprising:
a device order engine operable to accept an order from a user for shipment of one or more portable music devices, each portable music device operable to store and play songs;
a song order engine interfaced with the device order engine and operable to present the user with plural song titles for the user to select songs for copying to the portable music device; and
a song copy engine interfaced with the device order engine and the song order engine, the song copy engine operable to copy songs selected by the user to the portable music device before shipment of the portable music device.

11. The system of claim 10 wherein the song order engine is further operable to present the user with plural song format types for the user to select a format type for copying to the portable music device and wherein the song copy engine is further operable to copy the selected songs with the selected format type.

12. The system of claim 11 wherein the format type comprises the MP3 format type.

13. The system of claim 12 wherein the format type further comprises an encoding quality.

14. The system of claim 10 further comprising a song list generation engine interfaced with the song order engine and operable to generate a list of songs based on one or more predetermined factors and provide the list to the song order engine for ordering by the user.

15. The system of claim 14 wherein the predetermined factors comprise song genre type.

16. The system of claim 14 wherein the predetermined factors comprise song popularity.

17. The system of claim 14 wherein the predetermined factors comprise user demographics.

18. A method for manufacture of a portable music device, the method comprising:
receiving an order by a user for purchase of a portable music device, the order having plural song selections made by the user;
copying the song selections to a storage device of the portable music device; and
delivering the portable music device to the user with song selections copied into the storage device.

19. The method of claim 18 further comprising: receiving proof of rights of the user to one or more of the song selections.

20. The method of claim 18 further comprising:
randomly generating a list of song selections based on factors provided by the user; and
copy the list of song selections to the storage device of the portable music device.
